(19) United States
(12) Patent Application Publication
(10) Pub. No.: US 2013/0272698 A1
(43) Pub. Date: Oct. 17, 2013

(54) ADAPTIVE BIT OR POWER LOADING IN OPTICAL ORTHOGONAL FREQUENCY DIVISION MULTIPLEXING TRANSCEIVERS

(71) Applicants: Xianqing Jin, Bangor Gwynedd (GB); Jianming Tang, Chelmsford Essex (GB)

(72) Inventors: Xianqing Jin, Bangor Gwynedd (GB); Jianming Tang, Chelmsford Essex (GB)

(73) Assignee: Bangor University, Bangor Gwynedd (GB)

(21) Appl. No.: 13/885,599

(22) PCT Filed: Nov. 6, 2011
(86) PCT No.: PCT/EP11/69487

§ 371 Date: Jun. 21, 2013

(30) Foreign Application Priority Data
Nov. 15, 2010 (GB) 1019295.3

(51) Int. Cl. H04L 27/26; H04J 14/00

(52) U.S. Cl. CPC H04L 27/2601; H04J 14/00
USPC 398/43

(57) ABSTRACT

The present invention discloses a method for real time optical orthogonal frequency division multiplexing (OOFDM) transceivers by adaptively utilising available channel spectral characteristics.

### FIELD OF THE INVENTION

The present invention discloses a method to adaptively maximise the performance of high speed real time optical orthogonal frequency division multiplexing (OOFDM) transceivers by fully utilising available channel spectral characteristics.

### DESCRIPTION OF THE PRIOR ART

Optical OFDM (OOFDM) has recently been considered as a promising “future-proof” technique for next generation passive optical networks (PONs). OOFDM has the unique advantages of high spectral efficiency, great resistance to linear impairments, and dynamic provision of hybrid bandwidth allocation in both the frequency and time domains.

To improve the OOFDM transmission performance, system flexibility and compatibility, as well as performance robustness, adaptive loading on individual OOFDM subcarriers has been adopted via optimising bit and/or power distribution over all subcarriers according to the transmission channel state such as for example, frequency dependent noise/distortions within the signal spectral region. Typically, more bits or less power were applied to subcarriers with least noise/distortions and zero powers were allocated to subcarriers in deep fade.

Adaptive loading is effective in efficiently utilising the available system spectral characteristics determined by system and network elements. For instance, practical digital-to-analog converters (DACs) and low bandwidth optical modulators exhibit rapid analogue system frequency response roll-off. This allows narrowing of the system frequency response and causes significant variation in the achievable signal-to-noise-ratios (SNRs) across the subcarriers. In addition, adaptive loading can also be highly effective in reducing component impairments such as frequency chirp and nonlinear waveform distortions.

The three adaptive loading techniques typically used include bit-loading (BL), power-loading (PL) and bit-power-loading (BPL) as discussed for example in Tang et al. (J. M. Tang, P. M. Lane, and K. A. Shore, “High-speed transmission of adaptively modulated optical OFDM signals over multimode fibres using directly modulated DFBs,” J. Lightw. Technol., vol. 24, pp. 429-441, January 2006) or in Duong et al. (T. Duong, N. Genay, M. Ouzzif, J. L. Masson, B. Charbonnier, P. Chanclou, and J. C. Simon, “Adaptive loading algorithm implemented in AMOOFDM for NG-PON system integrating cost-effective and low-bandwidth optical devices,” Photon. Technol. Lett., vol. 21, pp. 790-792, June 2009) or in Yang et al. (H. Yang, S. C. Jeffrey Lee, E. Tangdiongga, C. Okonkwo, H. P. A. van den Boom, F. Breyer, S. Randel, and A. M. J. Koonen, “47.4 Gb/s transmission over 100 m graded-Index plastic optical fiber based on rate-adaptive discrete multitone modulation,” J. Lightw. Technol., vol. 28, pp. 352-358, February 2010).

Using the BL technique, Duong et al. experimentally achieved a 12.5 Gb/s adaptively modulated OOFDM signal transmission over 20 km single-mode fibre (SMF)-based intensity-modulation and direct-detection (IMDD) links. Using the BPL technique, Yang et al. experimentally demonstrated a signal bit rate as high as 47.4 Gb/s over 100 m graded-index plastic optical fibers (GI-POFs). These two experimental works were however undertaken in off-line DSP-based OOFDM systems, where the limitations imposed by the precision and speed of practical DSP hardware required for realising real-time high-capacity optical transmission were not considered. Very recently, Giddings et al. (R. P. Giddings, X. Q. Jin, E. Hugues-Salas, E. Giacoumidis, J. L. Wei, and J. M. Tang, “Experimental demonstration of a record high 11.25 Gb/s real-time optical OFDM transceiver supporting 25 km SMF end-to-end transmission in simple IMDD systems,” Optics Express, vol. 18, pp. 5541-5555, March 2010) experimentally demonstrated end-to-end real-time FPGA-based OOFDM transceivers employing the variable power loading (PL) technique successfully for transmitting 11.25 Gb/s, 64-QAM-encoded OOFDM signals over 25 km standard and MetroCor SMFs.

Generally speaking, the complexity of practically implementing BL and BPL in real-time OOFDM transceivers is significantly higher than that corresponding to PL. Indeed, in BL and BPL, subcarrier bit allocation varies considerably from system to system, and the BL and BPL operations are possible only by co-operation between the transmitter and the receiver. In traditional wireless OFDM systems operating at <500 Mb/s, BL and BPL are performed in an adaptive modulator and demodulator located prior to serial-to-parallel (S/P) in the transmitter and after parallel-to-serial (P/S) in the receiver, respectively, as discussed by Veilleux et al. (J. Veilleux, P. Fortier and S. Roy, “An FPGA implementation of an OFDM adaptive modulation system,” IEEE-NEWCAS Conference (2005), pp. 353-356, June 2005) or in Cui and Yu (X. Cui and D. Yu, “Digital OFDM transmitter architecture and FPGA design,” ASICON'09, pp. 477-480, October 2009) or in Wouters et al. (M. Wouters, G. Vanwijnsberghe, P. V. Wesemael, T. Huybrechts, S. Thoen, “Real time implementation on FPGA of an OFDM based wireless LAN modem extended with adaptive loading,” ESSCIRC 2002, pp. 531-534, September 2002) and as illustrated in FIG. 1 derived from Veilleux et al. In the transmitter/receiver, a suitable modulator/demodulator based on a specific signal modulation format is chosen for each individual subcarrier, according to the channel quality information measured via a feedback channel between the transmitter and the receiver. As each of these modulators outputs a complex number with a fixed bus width, S/P operating at a specific clock frequency can thus deal with the incoming signals at variable bit rates. For an OOFDM system operating at data rates larger than 10 Gb/s, the corresponding external clocks for inputing and outputing serial data have frequencies that are typically larger 1 GHz. This is much larger than the maximum clock frequency of a FPGA which is typically of less than 600 MHz. The BL and BPL functional blocks operate at the clock frequency of the FPGA. All the previously reported BL and BPL approaches implemented in wireless systems are therefore not suitable for high-speed real-time OOFDM systems. There is thus a need for developing new technologies, specific to these new high speed real time OOFDM systems.

### LIST OF FIGURES

FIG. 1 represents a diagram of a traditional adaptive bit-loading system.

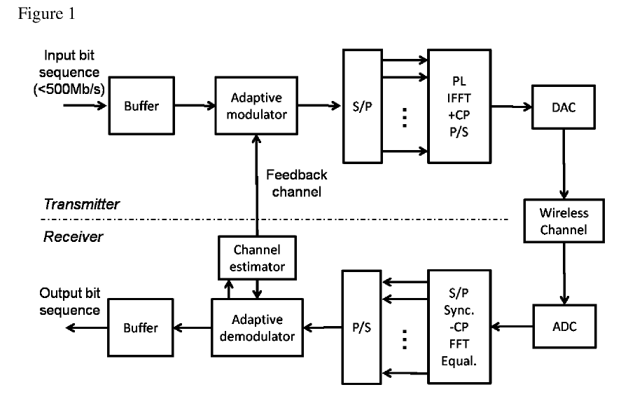

FIG. 2 represents a diagram of the adaptive bit-loading system according to the present invention.

FIG. 3 represents the structure of the parallel adaptive modulators and demodulators according to the present invention.

FIG. 4 represents a detailed real-time OOFDM transceiver diagram with PL, BL and BPL according to the present invention.

FIG. 5 represents the power distribution expressed in dB as a function of subcarrier index in the transmitter and receiver for bit loading (BL), power loading (PL) and bit and power loading (BPL), each normalised to its corresponding maximum power.

FIG. 6 represents respectively the bit distribution (to the left) and the bit error rate (BER) distribution (to the right) over all subcarriers using BL, PL and BPL at a sampling speed of 4 GS/s and over 25 km single mode fibres (SMFs).

FIG. 7 represents the transmission performance expressed in Gb/s using BL, PL and BPL as a function of sampling speed expressed in GS/s of analogue to digital converter (ADC) or DAC expressed in GS/s over 25 km single mode fibre (SMF).

FIG. 8 represents the transmission performance expressed in Gb/s using BL, PL and BPL as a function of transmission distance expressed in km with 4 GS/s ADC/DAC and a received optical power of less than −5.2 dBm.

### SUMMARY OF THE INVENTION

It is an objective of the present invention to maximise the performance of high speed real time OOFDM transceivers.

It is also an objective of the present invention to improve the performance robustness of high speed real time OOFDM transceivers.

It is also objective of the present invention to fully utilise available channel spectral characteristics.

It is another objective of the present invention to provide a cost-effective implementation of adaptive bit and/or power loading in high-speed real time OOFDM transceivers.

It is a further objective of the present invention to improve the adaptability to imperfect systems and components.

In accordance with the present invention, the foregoing objectives are described in the independent claims. Preferred embodiments are described in the dependent claims.

### DETAILED DESCRIPTION OF THE INVENTION

The present invention discloses a real-time optical OFDM system transceiver comprising a transmitter and a receiver.

The transmitter comprises:
a) a buffer outputting a fixed number of bits;
b) a serial to parallel converter,
c) a series of parallel adaptive modulators each comprising a bus width converter from c bits to d bits;
d) a field programmable gate array (FPGA) or an ASIC designed to carry out the operations of frequency to time domain transform, inserting a prefix in front of each symbol, said prefix being a copy of the end portion of the symbol and serialising the parallel symbols into a long digital sequence;
e) a digital to analogue converter;
f) an electrical to optical converter;

characterised in that the adaptive modulators are located after the serial to parallel converter.

The receiver comprises:
a) an optical to electrical converter;
b) an analogue to digital converter;
c) a FPGA or ASIC designed to carry out the operations of synchronisation, removal of the cyclic prefix, time to frequency domain transform, channel equalisation and serial to parallel conversion;
d) a series of parallel adaptive demodulators each comprising a bus width converter controlled by a signal similar to that used in the transmitter;
e) a parallel to serial converter;
f) a buffer controlled by a signal similar to that used in the transmitter. characterised in that the adaptive demodulators are located after the serial to parallel converter.

The present invention also discloses a method for maximising the performance of high speed real time optical OFDM transmitters by fully utilising available channel characteristics that comprises the steps of;
a) feeding the input data sequence having a variable bit rate into a buffer;
b) padding the buffer with a number of 0 bits to construct a fixed number of bits or fixed sequence length M for an OFDM symbol period, wherein M is equal to N×W, wherein N is the total number of subcarriers conveying data information and W is the bit width of the modulator using the highest signal modulation format level wherein the buffering operation is controlled by a signal generated by negotiations between the transmitter and the receiver via a specific channel.
c) applying a serial to parallel converter to the zero-padded bit streams from the buffer;
d) sending the parallel bit streams to N parallel adaptive modulators wherein parallel bits of width W are assigned to each modulator;
e) providing a bus width converter to extract the parallel bits assigned to each modulator, wherein those bits carry user data and wherein the converter operation is controlled by a signal generated by negotiations between the transmitter and the receiver via a specific channel.
f) applying a frequency to time domain transform to the sub-carriers using field programmable gate array (FPGA)or ASIC-based transform logic function algorithms in order to generate parallel OFDM symbols;
g) inserting a cyclic prefix (CP) in front of each symbol of step f), said prefix being a copy of the end portion of the symbol;
h) serialising these symbols using a parallel to serial converter in order to produce a long digital sequence;
i) applying a digital to analogue converter to convert the digital sequence into analogue waveforms;
j) applying an electrical to optical converter (E/O) to generate an optical waveform;
k) coupling the optical signal into a single mode fibre (SMF) or multimode fibre (MMF) or polymer optical fibre (POF) link.

OFDM is a multi-carrier modulation technique wherein a single high-speed data stream is divided into a number of low-speed data streams, which are then separately modulated onto harmonically related, parallel subcarriers, said subcarriers being positioned at equally spaced frequencies. Their overlapping spectra do not interfere at the discrete subcarrier frequencies thereby resulting in high spectral efficiency. In the transmitter, the frequency domain subcarriers are transformed into time domain symbols, and in the receiver the time domain symbols are transformed back into frequency domain subcarriers. The transforms used respectively in the transmitter and in the receiver must be of the same nature, preferably inverse and direct Fast Fourier Transforms (FFT). The transforms can also be Discrete Cosine Transforms.

The signal modulation formats are those typically used in the field and are described for example in Tang et al. (Tang J. M., Lane P. M., Shore A., in Journal of Lightwave Technology, 24, 429, 2006.). The signal modulation formats vary from differential binary phase shift keying (DBPSK), differential quadrature phase shift keying (DQPSK) and 2^{p} quadratic amplitude modulation (QAM) wherein p ranges between 3 and 8, preferably between 4 and 6. The information is thus compressed thereby allowing reduction of the bandwidth.

The serial to parallel converter truncates the zero-padded data streams and the encoders encode the parallel streams into a large number of sets of closely and equally spaced narrow-band data, the sub-carriers, wherein each set contains the same number of sub-carriers 2N. N is equal to 2^{p} wherein p is an integer of at least 3 up to 8, preferably, it is 7. In each parallel data, the amount of information is directly proportional to the clock beat. It ranges between 50 and 256 MHz.

The adaptive modulators are used to match the modulation, coding and other signal and protocol parameters to the conditions of the link, such as for example path-loss, interference, sensitivity, available power margin or other. The process of link adaptation is a dynamic process. Adaptive modulation therefore improves the rate of transmission and/or bit error rates by exploiting the channel state information present at the transmitter.

Discrete or fast Fourier transforms (DFT or FFT) are typically used as time to frequency domain transform. Preferably FFT is used as it reduces significantly the computational complexity, which however remains very computationally demanding.

The analogue to digital converter (ADC) is an electronic device that converts a continuous analogue signal to a flow of digital values proportional to the magnitude of the incoming signal. Most ADCs are linear, meaning that the range of the input values that map to each output value has a linear relationship with the output value. If the probability density function of a signal being digitised is uniform, the signal-to-noise ratio relative to the quantisation noise is ideal. As this is very rarely so, the signal has to be passed through its cumulative distribution function (CDF) before quantisation, thereby allowing quantisation of the most important regions with highest resolution.

The electrical to optical transformation is carried out with directly modulated distributed feedback (DFB) lasers, or SOAs/RSOAs, or VCSELs which are well known in the field. Coherent modulation and detection can also be used.

The length of the cyclic prefix copied in front of the symbol is determined in order to obtain a ratio (length of cyclic prefix)/(total length of symbol) ranging between 5% and 40%.

The optical fibres used in the present invention can be selected from single mode, multimode or polymer optical fibres.

The selection of the suitable adaptive modulator is controlled by using feedback information Sₖ received from the receiver via a feedback channel based on maximising raw bit rate.

The real-time OOFDM systems offer the advantages of on-line performance monitoring and live system parameter optimisation. Adaptive loading can thus be realised manually according to measured BERs and frequency responses obtained from channel estimation. The present invention focuses on maximising raw bit rate (Cₘₐₓ) by adaptive loading:

Cₘₐₓ=max(Σₖ₌₁^{N}^{_{sc}}bₖ/Tₛ) (1)

wherein bₖ is the number of bits loaded on the k-th subcarrier in one OOFDM symbol and Tₛ is the symbol period excluding the cyclic prefix, and wherein the net bit rate is proportional to raw bit rate.

An inverse path is used to detect the signal in the receiver which comprises the steps of:
a) detecting the transmitted OOFDM signals with an optical-to electrical converter (O/E);
b) applying an analogue to digital converter to convert the analogue waveform into a digital sequence;
c) applying a serial-to-parallel converter in order to transform the long serial sequence into parallel data;
d) synchronisation;
e) removing the cyclic prefix;
f) applying a direct time-to-frequency domain transform;
g) channel equalisation;
h) parallel demodulation of the complex valued sub-carriers;
i) using a bus width converter to form a bit output of width W with ‘0’ bit padding;
j) applying a P/S converter;
k) using the feedback-controlled receiver buffer to remove the extra ‘0’ bits from the output of the S/P converter.

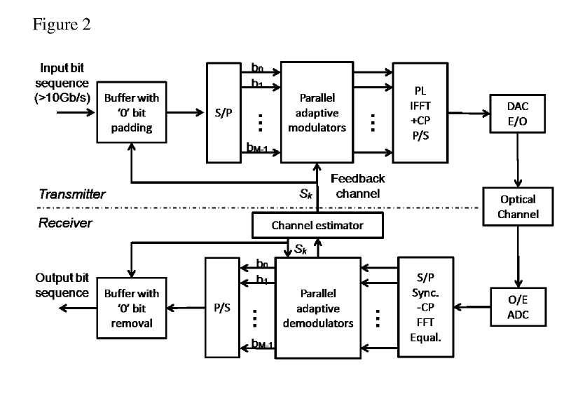

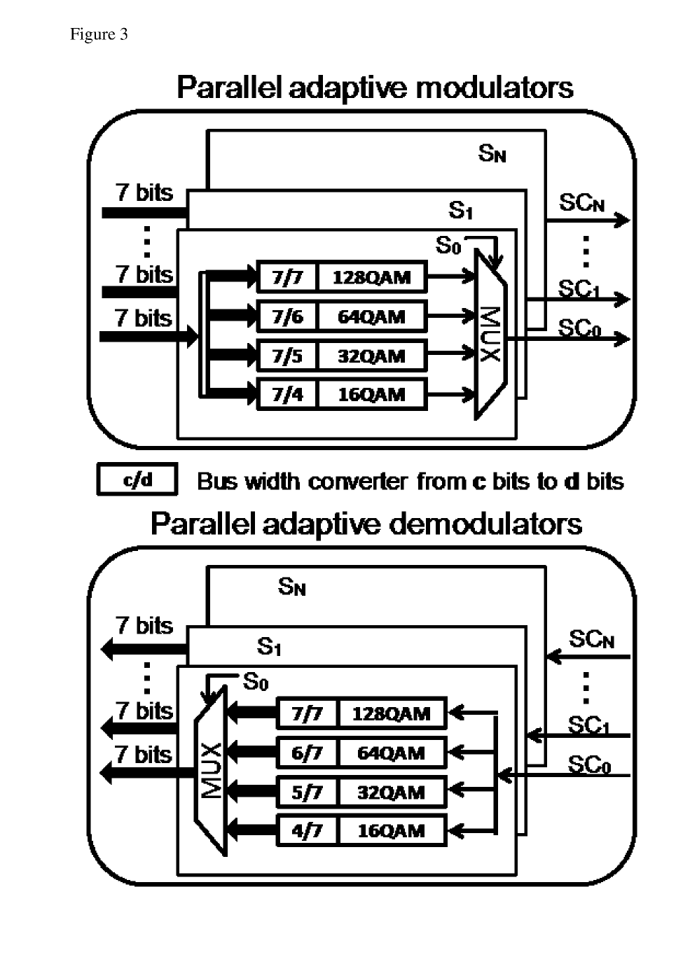

FIG. 2 represents the transmitter/receiver system used in the present invention and FIG. 3 is a detailed representation of the adaptive modulator and demodulator.

The synchronisation of step d) is carried out using the method described in Jin et al. (X. Q. Jin, R. P. Giddings, E. Hugues-Salas, and J. M. Tang, “Real-time experimental demonstration of optical OFDM symbol synchronization in directly modulated DFB laser-based 25 km SMF IMDD systems,” Optics Express, vol. 18, pp. 21100-21110, September 2010). The synchronisation technique uses subtraction and Gaussian windowing at the symbol rate. This technique is also described in co-pending patent application PCT/EP2010/066471.

The channel equalisation of step g) is based on advanced pilot subcarrier-assisted channel estimation, according to the method described in Jin et al. (Jin X. Q., Giddings R. P., and Tang J. M. in Optics Express, vol. 17, n. 17, 14574, 2009).

In comparison with previously published works, in the present invention, related to the field of high-speed real-time OOFDM transceivers, the adaptive modulator in the transmitter and the adaptive demodulator in the receiver have been physically moved to be located between the serial-to-parallel (S/P) and the parallel-to-serial (P/S) units. They thus utilise parallel signal processing at relatively low speed. The two major challenges associated with a typical OOFDM transceiver architecture design are resolved by the present invention. The two challenges are:
1. The variations of the corresponding data input/output interface for different application scenarios. The selected modulator using a specific signal modulation format for a subcarrier may be different for different applications, thus resulting in interface bus width variation.
2. The conversion of a signal bit sequence with a variable signal bit rate as opposed to that of a complex number sequence with a fixed bus width causes difficulties in transceiver designs. Even though the S/P and P/S clocks are not adjustable for a given OOFDM transceiver design, the S/P in the transmitter and the P/S in the receiver have to be able to convert an input data stream of different bit rates to a number of parallel data streams assigned respectively to the modulators or demodulators for different subcarriers.

The solution to these challenges is carried out by the two novel design features as displayed in FIG. 2. They allow the implementation of PL, BL and BPL in high-speed real-time OOFDM transceivers. These two important features are as follows:
1. Parallel adaptive modulators in the transmitter or demodulators in the receiver consist of a number of independent modulators or demodulators, each using specific signal modulation formats. A bus width converter is located in front of each modulator in the transmitter and after each demodulator in the receiver. The converter is used to produce a fixed data input/output interface, regardless of the use of BL and BPL for all different application cases.
2. A buffer with ‘0’ bit padding is also included to generate a number of bits required in an OFDM symbol period for input to the S/P in the transmitter, whilst another buffer in the receiver is also used to remove the added extra ‘0’ bits from the output bit sequence of the P/S.

The three techniques of bit loading (BL), power loading (PL) and bit-and-power loading (BPL) can be successfully used in the present invention.

For the BL technique, the modulation format on each subcarrier is varied iteratively according to the BER on each subcarrier whereas for the PL technique, it is the modulation power that is varied. In general, high modulation formats and/or less power are used on the subcarriers with lower noise/distortion and vice versa.

For the BPL technique, PL is first undertaken to satisfy the above two boundary conditions. After that, according to the subcarrier BER distribution, transmitted power distribution and received power distribution on all subcarriers, the modulation format and/or power on the subcarriers are adjusted to maximise the bit rate whilst maintaining the total channel BER less than 1×10⁻³. Subcarriers can be dropped subject to one of the following conditions: 1) for the BL technique, the subcarriers with the lowest modulation format and for the PL technique, the subcarrier with the highest power, both still suffer from excessive errors; 2) for the BPL technique, the subcarriers with lowest modulation format and highest power still suffer excessive errors.

### EXAMPLES

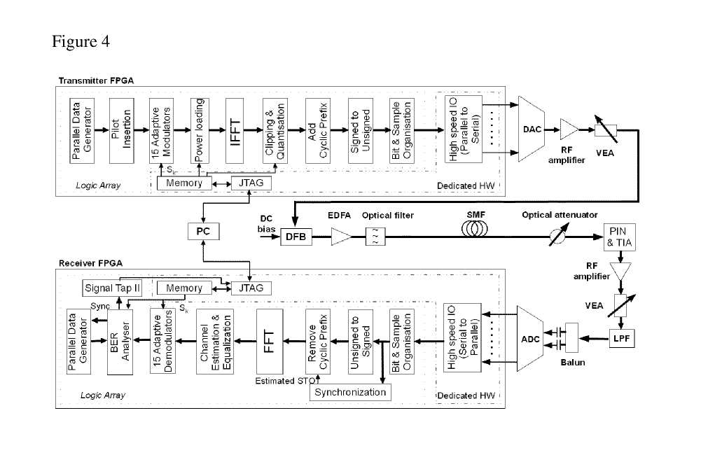

FIG. 4 shows a detailed real-time OOFDM transceiver diagram with PL, BL and BPL according to the present invention. The general real-time OOFDM transceiver architectures comprises transceiver parameters similar to those of the prior art such as for example described in Giddings et al. (R. P. Giddings, X. Q. Jin, E. Hugues-Salas, E. Giacoumidis, J. L. Wei, and J. M. Tang, “Experimental demonstration of a record high 11.25 Gb/s real-time optical OFDM transceiver supporting 25 km SMF end-to-end transmission in simple IMDD systems,” Optics Express, vol. 18, pp. 5541-5555, March 2010) or in Jin et al. (X. Q. Jin, R. P. Giddings, E. Hugues-Salas, and J. M. Tang, “Real-time experimental demonstration of optical OFDM symbol synchronization in directly modulated DFB laser-based 25 km SMF IMDD systems,” Optics Express, vol. 18, pp. 21100-21110, September 2010) or in Giddings et al. (R. P. Giddings, X. Q. Jin, and J. M. Tang, “First experimental demonstration of 6 Gb/s real-time optical OFDM transceivers incorporating channel estimation and variable power loading,” Optics Express, vol. 17, pp. 19727-19738, October 2009). It additionally comprises the novel features of the present invention.

The optical power injected into the MetroCor SMF was fixed at 7 dBm. The signal modulation format taken on each subcarrier was selected online from one of the followings: 16, 32, 64 or 128-QAM. The live selection and monitoring of the bit and/or power loading on each subcarrier in the transmitter and receiver was performed via the FPGAs' embedded logic analyser and memory editor via a JTAG connection to a PC.

Fifteen parallel adaptive QAM modulators/demodulators were implemented as schematically seen in FIG. 3, in order to treat the N=15 subcarriers conveying data information. As internal parallel data were used as a pseudo-random data source, in the transmitter, 105 (M=15×7) bits, including fixed pilot bits, for each OFDM symbol were generated in parallel as the input to the parallel modulators. The test bit pattern consisted of 88500 different symbols which were generated repeatedly. After assigning 7 bits to each parallel adaptive modulator as depicted in FIG. 3, a bus width converter was used in front of each modulator to extract only the number of bits assigned for each modulator. The signals Sₖ originating from online-controlled internal memory were used to select a suitable modulator output for data transmission on the k-th subcarrier. After the 15 parallel modulators, the power loading PL was realised by individually multiplying the output signal of each modulator by an online controlled gain coefficient to vary the subcarrier amplitude.

In the receiver, parallel samples exiting the 8-bit ADC and S/P converter were passed through a synchronisation unit, a Fast Fourier transform (FFT), a channel estimation and equalisation, and then to the 15 parallel demodulators. After demodulating the complex-valued subcarriers and selecting the appropriate demodulator output, a bus width converter was used after each demodulator to construct a 7-bit output by zero bit padding. The same signals Sₖ, which selected the demodulators, also selected the appropriate bits for error counting in the following BER analyser.

Based on the described real-time adaptive loading enabled OOFDM systems, bit and/or power loading of each subcarrier was adjusted to optimise the transmission performance over 25 km MetroCor SMF.

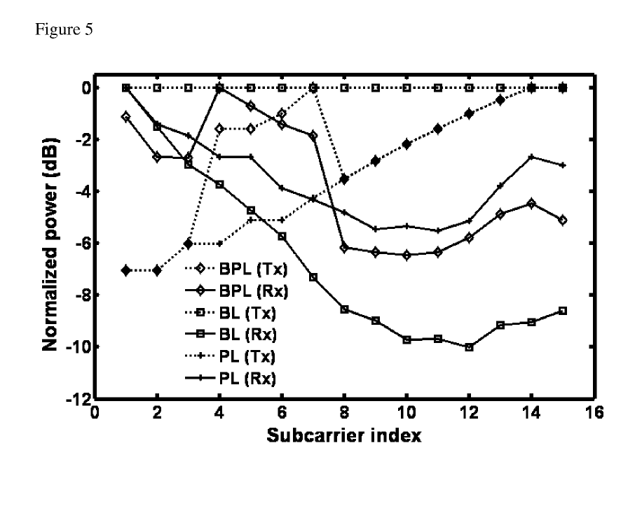

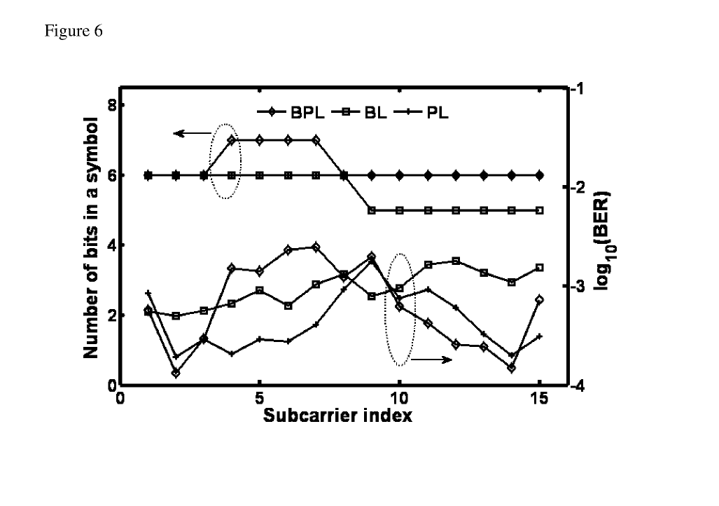

The results are presented in FIGS. 5 and 6 that show respectively the optimised power and bit distribution using the three techniques of BL, PL and BPL over 25 km MetroCor SMFs transmission at a sampling speed of 4 GS/s.

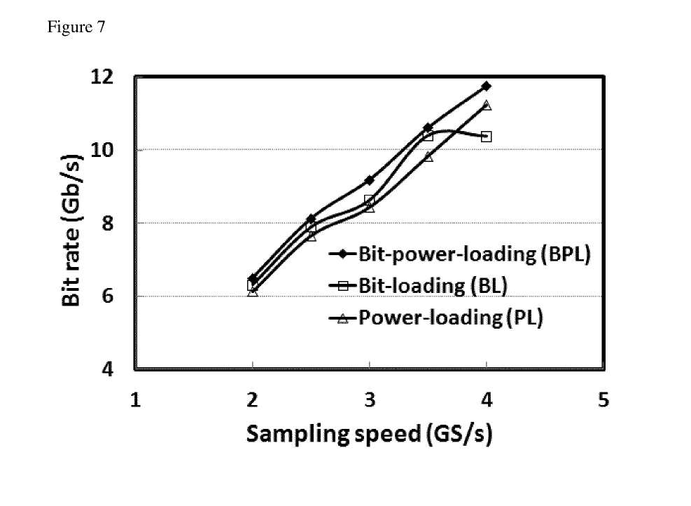

The maximum raw bit rate (Cₘₐₓ) obtained for OOFDM signals using the three techniques are shown in FIG. 7, where the sampling speed of the DAC/ADC ranges from 2 GS/s to 4 GS/s.

It can be seen that the BPL enabled the maximum transmission performance of 11.75 Gb/s at a sampling speed of 4 GS/s.

Over the whole sampling speed range, the BPL always achieved the best performance. PL achieved the worst performance except at the sampling speed of 4 GS/s. At that sampling speed, BL achieved the lowest performance. This general trend was consistent with the simulation results reported by Giddings et al. (R. P. Giddings, X. Q. Jin, E. Hugues-Salas, E. Giacoumidis, J. L. Wei, and J. M. Tang, “Experimental demonstration of a record high 11.25 Gb/s real-time optical OFDM transceiver supporting 25 km SMF end-to-end transmission in simple IMDD systems,” Optics Express, vol. 18, pp. 5541-5555, March 2010).

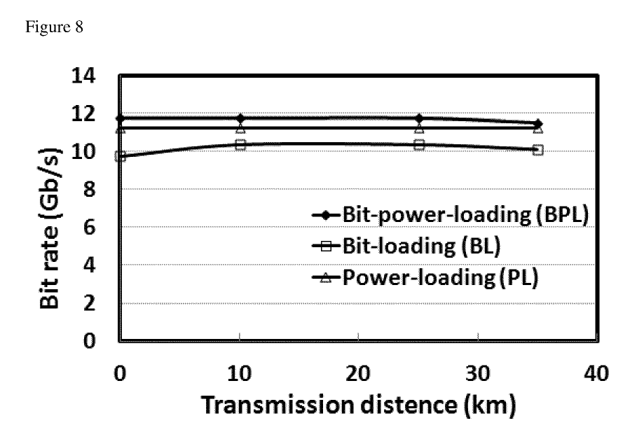

The transmission performance was also investigated at a sampling speed of 4 GS/s. The results can be seen in FIG. 8 displaying the curves of Cₘₐₓ as a function of different transmission distances at a sampling speed of 4 GS/s. Cₘₐₓ for the BPL and for the PL techniques was also higher than for the BL technique over transmission distances of up to 35 km. It indicated that the performance degradation for the BL technique was transmission-distance-independent and more importantly independent of the fibre link as it also had the lowest performance for the optical back-to-back case at a distance of 0 km. The reduced BL performance at 4 GS/s could be due to the imperfect sampling of the employed DAC/ADC at that speed, as BL is more sensitive to imperfect sampling-induced signal distortions compared with both PL and BPL. Therefore, the wider signal bandwidth suffered more high frequency roll-off associated with the DAC's analogue on-chip low-pass filtering. No power loading was used in the transmitter to pre-compensate the increased roll-off and so received subcarrier power for BL decreased more rapidly with frequency as shown in Fiure 7. This clearly increased the signal-to-noise ratio (SNR) at high frequencies. In addition the low amplitude subcarriers were more sensitive to the ADC quantisation noise. These effects reduced the maximum possible bits loaded on the subcarriers at high frequencies as seen from FIG. 6. From FIGS. 7 and 8, it can also be seen that BPL improved the bit rate by approximately 7% on average as compared with PL. It must be noted that the measured transmission performance in FIGS. 7 and 8 was obtained at minimal received optical power for achieving the lowest BER, which was fixed for each sample rate at less than −5.2 dBm in all cases.

For fair comparisons between the three techniques, two boundary conditions were satisfied: the total signal power over all subcarriers remained at a constant value at a given sample rate; and total BERs over all subcarriers was inferior to 10⁻³.

1 . An automatically synchronized optical orthogonal frequency division multiplexing (OFDM) transmission system, that includes an adaptive transmitter comprising:
a) a buffer outputting a fixed number of bits;
b) a serial to parallel converter;
c) a feedback information-controlled series of parallel adaptive modulators each comprising a bus width converter;
d) a field programmable gate array (FPGA) or an application specific integrated circuit (ASIC) designed to carry out the operations of frequency to time domain transform, inserting a prefix in front of each symbol, said prefix being a copy of the end portion of the symbol and serializing the parallel symbols into a long digital sequence;
e) a digital to analogue converter;
f) an electrical to optical converter; wherein the adaptive modulators are located after the serial to parallel converter.

2. A method for maximizing the performance of high speed real time optical orthogonal frequency division multiplexing (OFDM) transmitter by adaptively utilizing available channel spectral characteristics that comprises the steps of;
a) feeding the input data sequence having a variable bit rate into a buffer; b) padding the buffer with a number of 0 bits to construct a fixed number of bits or fixed sequence length M for an OFDM symbol period, wherein M is equal to N×W wherein N is the total number of subcarriers conveying data information and W is the bit width of the adaptive modulator using the highest signal modulation format, and wherein the buffering operation is controlled by a signal generated by negotiations between the transmitter and the receiver via a specific feedback channel. c) applying a serial to parallel conversion to the zero-padded data;
d) sending the parallel bit streams to N parallel adaptive modulators wherein parallel bits of width W are assigned to each modulator;
e) providing a bus width converter to extract the parallel bits assigned to each modulator, wherein those bits carry user data and wherein the converter operation is controlled by a signal generated by negotiations between the transmitter and the receiver via a specific channel. f) applying a frequency to time domain transform to the sub-carriers using field programmable gate array (FPGA)-based transform logic function algorithms in order to generate parallel OOFDM symbols;
g) inserting a cyclic prefix (CP) in front of each symbol of step f), said prefix being a copy of the end portion of the symbol;
h) serializing these symbols using a parallel to serial converter in order to produce a long digital sequence;
i) applying a digital to analogue converter to convert the digital sequence into analogue waveforms;
j) applying an electrical to optical converter (E/O) to generate an optical waveform;
k) coupling the optical signal into a single mode fiber (SMF) or multimode fiber (MMF) or polymer optical fiber (POF) link.

3. The method of claim 2 wherein the frequency-to-time domain transform is an Inverse Fast Fourier Transform.

4. The method of claim 2 wherein appropriate electrical powers are adaptively assigned to all encoded subcarriers according to the system frequency response of the channel.

5. An automatically synchronized optical orthogonal frequency division multiplexing (OFDM) transmission system that includes an adaptive receiver comprising :
a) an optical to electrical converter;
b) an analogue to digital converter;
c) a field programmable gate array (FPGA) or an application specific integrated circuit (ASIC) designed to carry out the operations of synchronization, removal of the cyclic prefix, time to frequency domain transform, channel equalization and serial to parallel conversion;
d) a series of parallel adaptive demodulators each comprising a bus width converter controlled by a signal similar to that used in the transmitter;
e) a parallel to serial converter; f) a buffer controlled by a signal similar to that used in the transmitter; the adaptive demodulators are located after the serial to parallel converter.

6. A method for receiving the signal transmitted by the method of claim 2 that comprises the steps of:
a) detecting the transmitted optical OFDM signals with an optical-to electrical converter (O/E);
b) applying an analogue to digital converter to convert the analogue waveform into a digital sequence;
c) applying a serial-to-parallel (S/P) conversion in order to transform the long serial sequence into parallel data;
d) synchronization;
e) removing the cyclic prefix;
f) applying a direct time-to-frequency domain transform;
g) channel equalization;
h) parallel demodulation of the complex valued sub-carriers;
i) using a bus width converter to form a bit output of width W with ‘0’ bit padding;
j) applying a parallel-to-serial (P/S) conversion;
k) using the feedback-controlled receiver buffer to remove the extra ‘0’ bits from the output of the S/P conversion.

7. The method of claim 6 wherein synchronization is carried out by subtraction and Gaussian windowing at the symbol rate.

8. An optical orthogonal frequency division multiplexing (OFDM) transceiver comprising;
an adaptive transmitter comprising:
a) a buffer outputting a fixed number of bits;
b) a serial to parallel converter;
c) a feedback information-controlled series of parallel adaptive modulators each comprising a bus width converter;
d) a field programmable gate array (FPGA) or an application specific integrated circuit (ASIC) designed to carry out the operations of frequency to time domain transform, inserting a prefix in front of each symbol, said prefix being a copy of the end portion of the symbol and serializing the parallel symbols into a long digital sequence;
e) a digital to analogue converter;
f) an electrical to optical converter; wherein the adaptive modulators are located after the serial to parallel converter; and
an adaptive receiver comprising:
g) an optical to electrical converter;
h) an analogue to digital converter;
i) a FPGA or ASIC designed to carry out the operations of synchronization, removal of the cyclic prefix, time to frequency domain transform, channel equalization and serial to parallel conversion;
j) a series of parallel adaptive demodulators each comprising a bus width converter controlled by a signal similar to that used in the transmitter;
k) a parallel to serial converter; and
l) a buffer controlled by a signal similar to that used in the transmitter; the adaptive demodulators located after the serial to parallel converter.

9. Use of the transceiver of claim 8 to maximize the performance of high speed real time optical OFDM and improve the performance robustness by adaptively utilizing available channel characteristics.

10. The method of claim 3 wherein appropriate electrical powers are adaptively assigned to all encoded subcarriers according to the system frequency response of the channel.
